(19) United States
(12) Patent Application Publication
(10) Pub. No.: US 2026/0115794 A1
(43) Pub. Date: Apr. 30, 2026

(54) METHOD FOR THE ADDITIVE MANUFACTURING OF A COPPER-STEEL MONOLITHIC ARTICLE

(71) Applicants: UT-Battelle, LLC, Oak Ridge, TN (US); University of Tennessee Research Foundation, Knoxville, TN (US)

(72) Inventors: Thomas Feldhausen, Oak Ridge, TN (US); Lauren Heinrich, Oak Ridge, TN (US); Blane Fillingim, Oak Ridge, TN (US); Brian K. Post, Oak Ridge, TN (US); Sudarsanam Suresh Babu, Oak Ridge, TN (US); Peeyush Nandwana, Oak Ridge, TN (US); Yousub Lee, Oak Ridge, TN (US)

(21) Appl. No.: 19/368,225

(22) Filed: Oct. 24, 2025

Related U.S. Application Data
(60) Provisional application No. 63/711,175, filed on Oct. 24, 2024.
(60) Provisional application No. 63/711,173, filed on Oct. 24, 2024.

(51) Int. Cl. B22F 10/28; B22F 7/02; B22F 10/50; B32B 15/01; B33Y 10/00; B33Y 40/00; B33Y 80/00

(52) U.S. Cl. CPC B22F 10/28; B22F 7/02; B22F 10/50; B33Y 10/00; B33Y 40/00; B33Y 80/00; B22F 2201/10; B22F 2301/10; B22F 2301/35; B22F 2998/10; B22F 2999/00; B32B 15/015; B32B 2250/02; B32B 2311/12; B32B 2311/30

(57) ABSTRACT

A method for manufacturing a monolithic multi-material article is provided. A first metallic material including copper is deposited to form a first portion. A second metallic material including a ferrous alloy is deposited onto the first portion to form a second portion. The portions are metallurgically bonded to create a single article. The first portion may be machined before over-deposition; the first portion can be maintained at 200-600° C. during deposition of the ferrous alloy. Representative parameter ranges include laser power 200-5000 W, traverse speed 200-2000 mm/min, energy density 30-200 J/mm³, and mass flow 5-50 g/min. Deposition can be performed with argon and/or helium shielding in an inert atmosphere with oxygen below 100 ppm. Ferrous alloys can include precipitation-hardenable stainless steels. The article can be a cooling insert for a mold or die.

### CROSS-REFERENCE TO RELATED APPLICATIONS

This application claims the benefit of U.S. Provisional Application 63/711,173, filed on Oct. 24, 2024, and U.S. Provisional Application 63/711,175, filed on Oct. 24, 2024, the disclosures of which are incorporated by reference in their entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to the field of additive manufacturing, and more specifically to a method of manufacturing a copper-steel monolithic article having excellent interfacial bonding and structural stability.

### BACKGROUND OF THE INVENTION

Tooling is critical for high-volume part manufacturing processes, including forming, molding, and injection molding of metals and plastics. Tooling components are typically manufactured from billets or cast materials, machined and polished into a final shape, and must exhibit wear resistance and hardness to withstand the demands of repeated thermal and mechanical cycles. However, such materials often suffer from reduced thermal conductivity compared to copper and aluminum alloys. This reduced thermal conductivity impairs the rate at which heat can be extracted from molded parts, thereby prolonging solidification times and increasing cycle duration. The cooling of components prior to ejection can account for over 70% of the molding cycle time.

Various strategies have been employed to increase the thermal response of tooling. Approaches such as gun drilling and copper sleeving of linear channels have been investigated to improve heat transfer, but these techniques are constrained by geometric limitations and cannot ensure uniform thermal extraction across complex tool geometries. Other approaches, such as conformal fluid channels and copper inserts, have demonstrated improvements in cooling efficiency. Despite these advances, challenges remain in balancing thermal conductivity, mechanical strength, and manufacturability of tooling components.

Additive manufacturing (AM) has emerged as a promising technology for tooling due to its ability to fabricate near-net-shape parts with customized internal features. AM processes allow for the integration of conformal cooling channels directly into the tooling structure, overcoming the design limitations of traditional negative machining. Materials such as maraging steels, stainless steels, and precipitation-hardened steels are commonly utilized in AM due to their favorable printability and mechanical properties. However, while steels offer strength and hardness, they exhibit relatively low thermal conductivity, limiting heat removal rates.

In recent years high-conductivity materials such as copper have been incorporated into tooling through additive manufacturing processes. Copper's thermal conductivity makes it highly desirable for heat transfer applications, but its reflectivity, low absorptivity of infrared laser wavelengths, and susceptibility to oxidation present significant challenges in laser-based AM systems such as selective laser melting (SLM). These issues often lead to lack-of-fusion defects, porosity, and difficulties achieving high-density copper components.

Despite recent progress, significant challenges persist in achieving dense, defect-free copper features within tooling components, particularly in multi-material systems combining copper with steels. Current methods suffer from difficulties in printing large volumes of copper, ensuring metallurgical bonding between dissimilar materials, and maintaining consistent material properties under industrial production conditions. There remains a need for improved methods of manufacturing tooling that integrate both high-conductivity and high-strength materials, with robust control over microstructure, interface integrity, and thermal performance.

### SUMMARY OF THE INVENTION

A method of manufacturing a monolithic multi-material article is provided. The method includes additively depositing via laser-based directed energy deposition a first metallic material including copper to form a first portion. The method further comprises additively depositing via laser-based directed energy deposition a second metallic material comprising a ferrous alloy onto the first portion to form a second portion. The first portion and the second portion are metallurgically bonded to form a monolithic article.

A monolithic article is also provided. The monolithic article is manufactured by the method.

These and other features of the invention will be more fully understood and appreciated by reference to the description of the embodiments and the drawings.

### BRIEF DESCRIPTION OF THE DRAWINGS

FIG. 1 is a schematic depicting alternative interface-preparation pathways in a laser-based directed energy deposition process for manufacturing a monolithic copper-steel article.

FIG. 2 is a schematic depicting the geometry of a deposited cube sample including cross-sectional surface relative to the cube center line and borders.

FIG. 3 is a schematic of a copper-steel sample with a tapered interface showing the imaged surface extending from +2 mm above to-2 mm below the interface for microstructural evaluation.

FIG. 4 is a cross-sectional image of copper-steel interfaces produced under different energy densities and interface conditions, demonstrating variations in dilution, cracking, and fusion quality across the analyzed regions.

FIG. 5 is a graphical depiction of dilution % of two copper-steel interfaces produced under different interface conditions as a function of energy density.

FIG. 6 is a graphical depiction of density % of two copper-steel interfaces produced under different interface conditions as a function of energy density.

### DETAILED DESCRIPTION OF THE CURRENT EMBODIMENTS

As discussed herein, the current embodiments relate to a method of manufacturing a monolithic multi-material article. The method includes the step of additively depositing via laser-based directed energy deposition a first metallic material including copper to form a first portion. A second metallic material comprising a ferrous alloy is additively deposited onto the first portion to form a second portion via laser-based directed energy deposition. The first portion and the second portion are metallurgically bonded to form a monolithic article.

The method includes the step of additively depositing a first metallic material including copper to form a first portion. The first metallic material comprises copper. In certain embodiments, the first metallic material consists essentially of, or alternatively consists of copper. In alternative embodiments however, the first metallic material includes copper in an amount of 20 to 99 wt. %, alternatively 50 to 95 wt. %, alternatively 70 to 95 wt. %, alternatively 90 to 95 wt. %, or alternatively 93 to 94 wt. %.

The first metallic material may therefore be a copper alloy, wherein the alloy further includes one or more secondary metallic constituents selected to enhance printability, interfacial stability, and metallurgical compatibility with the subsequently deposited second metallic material. In certain embodiments, the copper alloy comprises iron or steel which may be co-deposited with copper to form a copper-steel alloy mixture. Suitable examples of steel include precipitation-hardenable stainless steels, martensitic stainless steels, and other ferrous alloys capable of forming a metallurgical bond with copper or a copper alloy. In certain embodiments, the steel comprises a precipitation-hardenable stainless steel such as 17-4PH stainless steel (UNS S17400). In other embodiments, the steel may include 15-5PH stainless steel, 13-8PH stainless steel, 420 stainless steel, 316L stainless steel, or tool steels such as H13 or P20. The incorporation of a limited amount of iron or steel within the copper matrix has been found to reduce process instability during directed energy deposition, mitigating spatter formation and promoting uniform melt-pool behavior.

The resulting copper-steel alloy may exhibit improved absorption of laser energy and reduced reflectivity relative to pure copper, thereby facilitating consistent layer formation and interlayer fusion. Furthermore, the presence of the ferrous constituent within the copper phase enhances metallurgical compatibility at the subsequent copper-to-steel interface, reducing the likelihood of delamination or hot cracking upon deposition of the ferrous alloy portion. In certain embodiments, the copper alloy may contain minor additions of elements such as nickel, chromium, or silicon.

The laser-based directed energy deposition (DED) process utilized in the present method employs a focused laser beam as a localized heat source to create a melt pool on a substrate surface while simultaneously delivering metallic feedstock, such as powder or wire, into the melt pool to form successive solidified layers. The laser may operate at an infrared wavelength (e.g., ˜1.0-1.1 μm), a visible green wavelength (e.g., ˜515-532 nm), or a visible blue wavelength (e.g., ˜445-460 nm), selected in view of absorption characteristics of the copper-containing first metallic material and the ferrous second metallic material. In some embodiments, green or blue wavelengths may be used while depositing the first portion to enhance absorption, and infrared may be used for the second portion, or a single wavelength may be used for both portions for simplicity.

Copper and copper-containing alloys have inherently high thermal conductivity and high infrared reflectivity of copper. These characteristics cause rapid heat dissipation and inefficient laser energy absorption, which can result in poor melt-pool stability, lack of fusion, and process interruption. To overcome these difficulties, the present method employs process parameters including laser power, traverse speed, and powder mass flow rate to achieve sufficient energy density for stable deposition. In certain embodiments, the laser power may range from 200 to 5000 watts, alternatively 500 to 2000 watts, or alternatively 600 to 1200 watts. The traverse speed may range from 200 to 2000 mm/min, alternatively 500 to 1500 mm/min, or alternatively 600 to 1200 mm/min. The volumetric energy density (AKA VED or energy density) is between 30 and 200 J/mm³, alternatively 50 to 150 J/mm³, or alternatively 60 to 120 J/mm³. The mass flow of the first metallic material is from 5 to 50 g/min, alternatively 15 to 40 g/min, or alternatively 15 to 25 g/min.

Inert gas shielding and low-oxygen processing environments further stabilizes the deposition of copper by preventing oxidation and associated absorption variability. In certain embodiments, the process atmosphere is maintained at an oxygen concentration below 100 parts per million, utilizing argon, helium, or mixtures thereof as the shielding gas. Helium may be particularly advantageous for copper deposition due to its higher thermal conductivity and reduced tendency to form plasma during laser interaction, thereby improving melt-pool uniformity and interlayer adhesion.

In some embodiments, the first metallic material is deposited on a substrate comprising a ferrous alloy, e.g., precipitation-hardenable stainless steels, martensitic stainless steels, austenitic stainless steels, or tool steels. Examples include 17-4PH (UNS S17400), 15-5PH, 13-8PH, 420, 316L, H13, and P20. In a representative sequence, a ferrous substrate is fixtured, the surface is prepared (e.g., by grit blasting, machining, or solvent cleaning), and the first portion is deposited using copper or copper-alloy feedstock to a desired height, followed by over-deposition of the second metallic material to form the second portion.

The method may further comprise machining at least part of a surface of the first portion to give a machined surface, and the second metallic material is subsequently additively deposited onto the machined surface via laser-based directed energy deposition. Machining may include one or more of milling, turning, fly-cutting, grinding, honing, or abrasive brushing, alone or in combination. In some embodiments, machining is carried out by end-milling with a carbide tool followed by a light finishing pass to remove oxides and re-entrant asperities that can inhibit wetting during deposition of the second metallic material. The machined surface may exhibit an average surface roughness (Ra) of less than 10 μm, alternatively less than 7 μm, alternatively less than 5 μm, alternatively from 0.5 to 3 μm, measured, for example, in accordance with ISO 4287 or ASME B46.1. In some embodiments, machining is followed by non-residue cleaning (e.g., solvent wipe or ultrasonic cleaning in isopropyl alcohol) and optional inert-gas brushing to remove loose particulates. The machining step may be performed immediately prior to deposition of the second metallic material to limit re-oxidation of the copper-containing surface, in some embodiments within 5-60 minutes, alternatively within 5-20 minutes of the over-deposition step. In certain embodiments, the method includes maintaining the first portion at a preheat temperature between 200° C. and 600° C. during deposition of the second metallic material.

The method further includes additively depositing via laser-based directed energy deposition a second metallic material comprising a ferrous alloy onto the first portion to form a second portion. The second metallic material generally includes a ferrous alloy, e.g., precipitation-hardenable stainless steels, martensitic stainless steels, austenitic stainless steels, or tool steels. Examples include 17-4PH (UNS S17400), 15-5PH, 13-8PH, 420, 316L, H13, and P20.

In certain embodiments, the second metallic material is deposited onto the first portion by laser-based directed energy deposition using powder and/or wire feedstock. Deposition of the second metallic material may be conducted at a laser power of 200 to 5000 W, alternatively 500 to 3000 W, alternatively 900 to 1800 W, alternatively 1200 to 1700 W. The traverse speed may be 200 to 2000 mm/min, alternatively 500 to 1500 mm/min, alternatively 600 to 1200 mm/min, alternatively 700 to 1000 mm/min. The volumetric energy density may be 30 to 200 J/mm³, alternatively 60 to 150 J/mm³, alternatively 70 to 110 J/mm³, alternatively 90 to 105 J/mm³. The mass flow rate of the second metallic material may be 5 to 50 g/min, alternatively 10 to 35 g/min, alternatively 12 to 25 g/min, or alternatively 14 to 22 g/min.

In some embodiments, a starter-layer regime is utilized for the first 2 to 5 layers of the second metallic material at the copper/ferrous interface to establish dilution and wetting. The starter-layer regime may employ laser power of 0.9 to 1.5 kW, alternatively 1.0 to 1.3 kW; traverse speed of 500 to 900 mm/min, alternatively 600 to 800 mm/min; VED of 80 to 160 J/mm³, alternatively 100 to 140 J/mm³; and mass flow of 10 to 20 g/min, alternatively 12 to 18 g/min. In certain embodiments, the layer height during the starter layers is 0.20 to 0.40 mm, alternatively 0.25 to 0.35 mm, and track overlap is 30 to 55%, alternatively 35 to 50%, to promote uniform bead geometry and continuous fusion on the machined copper-containing surface.

Thermal management sequencing may include a laser dwell on the machined copper-containing surface prior to the first steel pass for 1 to 15 s, alternatively 2 to 10 s, to equilibrate the interfacial temperature within the desired preheat band. During transition from the starter-layer regime to the bulk-fill regime, incremental adjustments to power, speed, and mass flow may be applied over 1 to 3 layers to avoid abrupt changes in bead geometry.

As used herein, “metallurgically bonded” refers to bonding at the interface between the first portion and the second portion characterized by fusion at the interface and interdiffusion of constituents sufficient to produce an integral, crack-free joint under optical or electron microscopy at customary magnifications. In certain embodiments, the interface exhibits no visually continuous lack-of-fusion defects and no continuous through-thickness cracking. In some embodiments, the interface region includes a dilution zone having a thickness of 5 to 200 μm, alternatively 10 to 100 μm, alternatively 20 to 60 μm, with a graded composition from the copper-containing first portion to the ferrous second portion.

A monolithic article manufactured by the method is further provided. The article includes a first portion formed from a first metallic material comprising copper and a second portion formed from a second metallic material comprising a ferrous alloy, the portions being metallurgically bonded to one another to define a single, unitary body. The first portion provides enhanced thermal conductivity and heat spreading, while the second portion provides mechanical strength, wear resistance, and attachment features suitable for service in tooling environments.

In certain embodiments, the article is a cooling insert for a mold or die. The insert may be configured to sit within a cavity block or core and to conduct heat away from a hot region of the tooling during cyclic operation. The first portion is positioned proximate to a heat-transfer surface of the insert and is thermally coupled to one or more internal cooling channels. The second portion provides a structural framework that supports the copper-containing region, integrates mounting geometries, and interfaces with the surrounding tool steel.

The cooling insert may incorporate conformal channels (i.e., fluid passages that follow the contour of the heat-loaded surface with substantially constant or prescribed stand-off from that surface). Conformal channels may have circular, oval, racetrack, or teardrop cross-sections, and may include helical, serpentine, bifurcated, or manifolded flow paths. In some embodiments, the channel diameter is about 2 to 10 mm, alternatively about 3 to 8 mm, and the channel stand-off from the heat-transfer surface is about 0.5 to 5 mm, alternatively about 1 to 3 mm, selected to balance heat extraction with structural integrity.

By situating the first portion adjacent to the conformal channels and the heat-loaded surface, the article provides rapid heat uptake and lateral heat spreading, promoting lower peak surface temperatures, reduced thermal gradients, and improved temperature uniformity across the molded surface. The second portion confines and directs the channels, resists mechanical and thermal loads, and offers machinable lands for sealing features, fasteners, and datum surfaces.

As a result of the metallurgical bond during additive build, the cooling insert forms a leak-resistant, delamination-resistant structure without intervening brazes or adhesives. The bonded interface accommodates thermally induced strains during operation and mitigates crack initiation associated with discrete joints. The monolithic nature of the body further reduces thermal contact resistance at internal interfaces and can improve service life under cyclic heating and cooling.

Fluid connections may be provided by integral ports, bosses, or threads formed in the second portion and communicating with the conformal channels. In certain embodiments, flow conditioners (e.g., fillets, diffuser sections, or turn radii) are integrated at bends to reduce pressure drop and erosion. Internal surfaces may be as-built or post-processed (e.g., via abrasive flow finishing) to achieve a target surface roughness suitable for stable flow and fouling control.

The first portion may be pure copper or a copper alloy as described herein and may optionally include localized thickened regions or heat-spreader ribs positioned between the conformal channels and the heat-loaded surface. The second portion may comprise a precipitation-hardenable stainless steel, such as 17-4PH. Geometric relations between the portions may be tailored so that the first portion defines caps, linings, or shells overlying the channel network, while the second portion defines backing structures, webs, or frames that tie the insert into the surrounding tool. In some embodiments, transition regions in which the copper-containing and ferrous materials intermix over a finite dilution zone are present along the interface to further stabilize the bond and to moderate coefficient-of-thermal-expansion mismatch during operation.

### EXAMPLES

A hybrid machine tool integrating additive and subtractive manufacturing operations in a single platform was utilized to characterize various interfacial conditions between copper and steel (i.e., an Okuma MU-8000V-L LASER EX system equipped with a laser-directed energy deposition (DED) head such as a Trumpf TruDisk 4002 laser operating at an infrared wavelength of approximately 1,030 nm). The laser source had a maximum output power of about 4,000 watts. The deposition optics provide a programmable spot size ranging from approximately 0.6 mm to 6 mm in diameter.

In the following examples, a laser power of about 4,000 watts at a 6 mm spot size was employed. Cubic specimens having nominal dimensions of approximately 35 mm×35 mm were manufactured, wherein the programmed cube outer dimension was approximately 41 mm to account for bead width. The infill centerline is offset approximately 2 mm from the border centerline, with infill hatch spacing of about 3 mm, indexed by 90° between successive layers. The programmed layer height was varied depending on the feedstock material.

A ferrous alloy material (17-4PH stainless steel powder) (Oerlikon MetcoAdd 17-4PH-D with a particle size distribution of about −106/+45 μm, having a nominal chemical composition of Fe-17Cr-4Ni-4Cu-0.3Nb(+Ta)) was used. The mass flow rate was varied from 15 to 35 g/min in 5 g/min increments. The layer height was calibrated to within 10% of the total desired height (i.e., between 35-38.5 mm in total height). Deposition parameters suitable for this material were varied as shown in Table 1.

TABLE 1

| Parameter | Value | Unit |
|---|---|---|
| Traverse speed | 700 | mm/min |
| Spot size | 6 | mm |
| Laser power | 4,000 | watts |
| Border gap | 2 | mm |
| Infill hatch spacing | 3 | mm |
| Deposition tilt angle | 12, 0 | deg |
| Mass flow | 10, 15, 20, 25, 30, 35 | g/min |
| Argon nozzle gas | 10 | l/min |
| Helium carrier gas | 5 | l/min |
| Programmed layer height | 0.62, 0.85, 1.20, 1.45, 1.60, | mm/lyr |
| | 1.75, 2.22 | |
| Interlayer dwell | 1 | sec |

Pure copper was processed at a powder feed rate of 20-30 g/min. The deposition parameters for this condition are summarized in Table 2. The copper feedstock in this case was Oerlikon Metco 55 powder with a particle size distribution of-90/+38 μm and a nominal copper content of 99.0 wt. %.

TABLE 2

| Parameter | Value | Unit |
|---|---|---|
| Traverse speed | 1,400 | mm/min |
| Spot size | 6 | mm |
| Laser power | 4,000 | watts |
| Border gap | 2 | mm |
| Infill hatch spacing | 3 | mm |
| Deposition tilt angle | 12 | deg |
| Mass flow | 20, 25, 30 | g/min |
| Argon nozzle gas | 10 | l/min |
| Helium carrier gas | 5 | l/min |
| Programmed layer height | 0.38, 0.523, 0.65 | mm/lyr |
| Interlayer dwell | 5, 2-10 | sec |

Pure copper was deposited at a constant lean of 12°. This lean was selected to prevent back reflection damage to the hybrid machine tool. The pure copper deposition was observed to be unstable.

A mixed copper and 17-4PH feedstock was used with a weight loading of 6.2 to 93.8 wt. % copper. The deposition parameters for the exemplary mixture are shown in Table 3 below.

TABLE 3

| Parameter | Value | Unit |
|---|---|---|
| Traverse speed | 700 | mm/min |
| Spot size | 6 | mm |
| Laser power | 4,000 | watts |
| Border gap | 2 | mm |
| Infill hatch spacing | 3 | mm |
| Deposition tilt angle | 12 | deg |
| Mass flow, 17-4 PH | 1.2-18.8 | g/min |
| Mass flow, Copper | 1.2-18.8 | g/min |
| Argon nozzle gas | 10 | l/min |
| Helium carrier gas, 17-4 PH | 3-5 | l/min |
| Helium carrier gas, Copper | 2-3 | l/min |
| Programmed layer height | 1.1-1.0 | mm/lyr |
| Interlayer dwell | 5, 10 | sec |

The feedstock mixture was deposited at a constant lean of 12°. This lean was used to prevent back reflection damage to the hybrid machine tool.

Open Mind's hyperMILL was used for the computer aided design (CAD) and computer aided manufacturing (CAM) programming of the hybrid machine tool path. A Contour Milling on 3D tool path was used, followed by the Additive Manufacturing tool path which was reworked using 5X Rework Machining with a radial Z tilt at the desired angle, and then finally generated the usable toolpath with the Additive Manufacturing tool path.

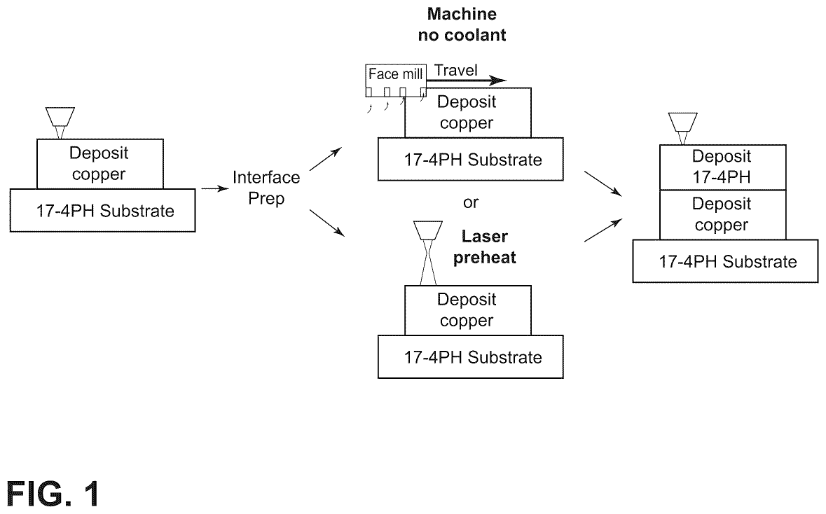

Each exemplary material was tested with a variety of interface conditions. A diagram of the various interface preparations is depicted in FIG. 1. Conditions where the interface was not machined or heated were not included in the diagram because no operations were executed on the as-printed surface.

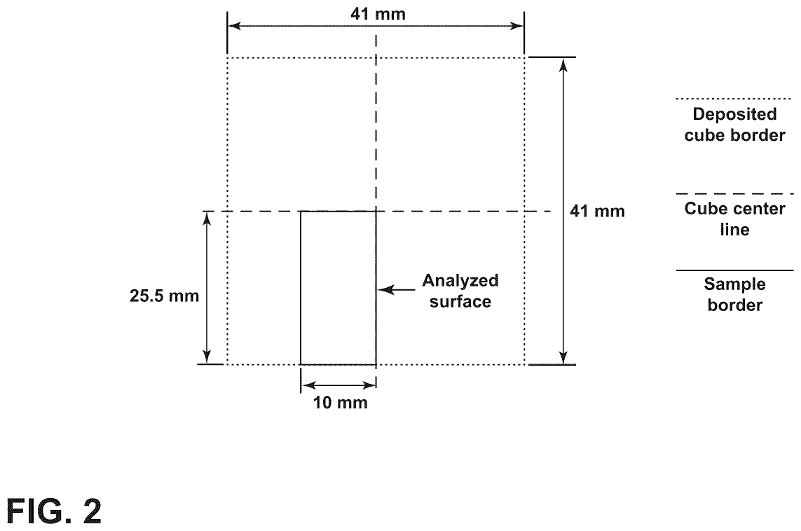

Each material sample was deposited on 76.2 mm round stock with a 50 mm machined square pedestal, 8 mm below the deposition surface. This geometry was selected to minimize machining after material deposition to achieve a 41 mm square (35 mm cube border centerline+6 mm spot size). 8 mm of depth was selected to allow enough substrate material for dilution zone optical analysis. A 35 mm cube sample size was selected. The evaluation sample geometry is depicted in FIG. 2.

For the as-printed interface condition without machining, 35 mm cube of copper was printed up to 17.3 mm tall to account for 2.3 mm being removed when sawing the sample from the substrate. For the machined interface, copper was printed to 18.3 mm tall then machined to 17.3 mm tall. The top segment of 17-4PH was then printed on top where the first 4.4 mm were at a 12° tilt to prevent back reflection damage, and then the last 10.6 mm of material was printed on top normal to the substrate with a total target height of 30 mm after sawing from the substrate. The sample was then machined to 35 mm square, 32.5 mm tall, and cross sectioned where the center of the sample was along the left edge of the imaged sample at 17.5 mm wide. Pure copper tested with three surface conditions that can be seen in Table 4. The pure copper interface conditions were only evaluated with all hot interfaces.

TABLE 4

| Parameter | Condition 1 | Condition 2 | Condition 3 |
|---|---|---|---|
| Machined Interface | No | Yes | Yes |
| Interface | Hot | Hot | Hot |
| Temperature | | | |
| Preheat | No | No | No |

It is believed that steel would not fuse to copper with a cold interface. It is believed this phenomenon is a result of the immiscibility gap, low infrared absorptivity, and the high thermal conductivity of copper. The copper/17-4PH mixture was also evaluated. The conditions were tested can be seen in Tables 5 and 6.

TABLE 5

| Parameter | Condition 1 | Condition 2 | Condition 3 | Condition 4 |
|---|---|---|---|---|
| Machined | No | No | No | No |
| Interface | | | | |
| Interface | Hot | Cold | Cold | Hot |
| Temperature | | | | |
| Preheat | No | No | Yes | Yes |

TABLE 6

| Parameter | Condition 5 | Condition 6 | Condition 7 | Condition 8 |
|---|---|---|---|---|
| Machined | Yes | Yes | Yes | Yes |
| Interface | | | | |
| Interface | Hot | Cold | Cold | Hot |
| Temperature | | | | |
| Preheat | No | No | Yes | Yes |

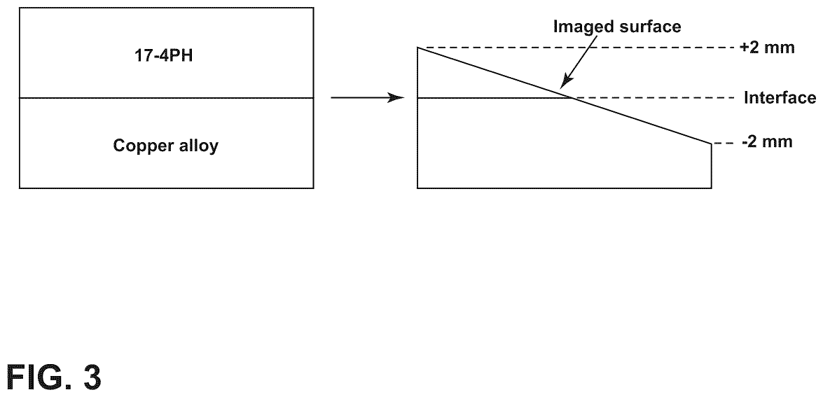

Two of the interface conditions, condition 1 (hot as-printed interface) and condition 5 (hot machined interface), were further analyzed utilizing a tapered interface to further characterize the cracking and dilution zones at differing energy densities. A 35 mm cube of copper was printed, 8 mm tall for the as-print surface condition and 9 mm tall, then machined to 8 mm, for the machined interface condition. 17-4PH was then printed on top, where the first 4.4 mm was printed at a 12° tilt to prevent back reflection damage to the hybrid machine tool. The entire sample was then machined to a 30 mm square. Condition 5 was selected for further analysis because of its high-quality interface. Condition 1 was also selected because of its print flexibility with complex surfaces without additional machining. The fewer discontinuities in the interface, the less time it takes to machine components, minimizing temperature drop. The relevant geometry is depicted in FIG. 3.

Each sample was printed as a 35 mm square, and then machined with a taper where the top was at 10 mm and the bottom edge was at 6 mm from the substrate for a range of +2 mm across the interface. This morphology enabled a higher resolution analysis area along the interface between the copper and steel. Two different printing methods were analyzed. Changes in printed layers were used to evaluate the effect of remelt on interface cracking and change in energy density by decreasing mass flow and laser power.

A first tapered section analysis was used to evaluate how a change in the numbers of layers printed on top of the copper would affect the interfacial cracking. The nominal 17-4PH printing parameters were utilized as discussed in Table 1 where laser power and mass flow held constant. Printing conditions for the first tapered section analysis is shown in Table 7 below.

TABLE 7

| Layers Deposited | Build Height [mm] |
|---|---|
| 1 | 2.2 |
| 2 | 4.4 |
| 3 | 6.6 |
| 4 | 8.8 |

The effect of an increase in energy density was evaluated where the powder mass flow was decreased and where the laser power was decreased. The laser power could not be increased to increase the energy density because the maximum laser power (4000 watts) was already being used for the 30 g/min mass flow. The mass flow rate could not be increased to reduce energy density because the powder feeding hardware could only feed about 30 g/min with one hopper. Instead, laser power was decreased. Volumetric energy density was defined as follows.

$$\frac{P * 60}{L * H * V} = J / {mm}^{3}$$

P=laser power in watts; L=actual layer height in mm; H=hatch spacing in mm; V=velocity in mm/min; and J=joules.

A decrease in mass flow of the 17-4PH was used to increase the energy density as mass flow affects the as-printed layer height. As layer height decreases, the energy density increases. The number of layers deposited was increased to achieve the same total nominal height of about 4.4 mm determined from 2 deposited layers at the nominal mass flow of 30 g/min. Laser power was decreased from 3500 to 2500 watts to evaluate lower energy densities. Changes in energy density from variations of mass flow rate, number of layers, and laser power can be shown in Table 8 below.

TABLE 8

| Energy | Density Mass | Number of | Total Build | Laser Power |
|---|---|---|---|---|
| [J/mm³] | Flow [g/min] | Layers | Height [mm] | [W] |
| 160 | 10 | 6 | 4.3 | 4000 |
| 103 | 20 | 4 | 4.45 | 4000 |
| 52 | 30 | 2 | 4.4 | 4000 |
| 45 | 30 | 2 | 4.4 | 3500 |
| 39 | 30 | 2 | 4.4 | 3000 |
| 32 | 30 | 2 | 4.4 | 2500 |

A FLIR A700 infrared camera was used to capture thermal data of the deposition process. The data was analyzed utilizing python where the maximum pixel temperature was extracted and graphed to determine the maximum interlayer temperature. The metallography samples were mounted in 50 mm sample mount. A Buchler SimpliMet 3000 automatic mounting press with KonductoMet was used for the mounting of the cross-section samples evaluated with a mounting pressure 290 bar at 180° C. Grinding and polishing steps were performed using a Buehler AutoMet 300 Pro are shown in Tables 9 and 10 below.

TABLE 9

| Grinding Grit | Force [N] | Time [min] | Lubricant |
|---|---|---|---|
| 320 | 20 | 2 | Water |
| 500 | 20 | 2 | Water |
| 800 | 20 | 2 | Water |
| 1000 | 20 | 2 | Water |
| 2000 | 20 | 2 | Water |

TABLE 10

| Polishing Suspension | | | |
|---|---|---|---|
| [μm] | Force [N] | Time [min] | Lubricant |
| 6 | 30 | 12 | DP Yellow |
| 3 | 30 | 12 | DP Yellow |
| 1 | 30 | 12 | DP Yellow |

Each sample was imaged using a Leica DM4000M at 50× magnification with a resolution of 1 μm per pixel for porosity analysis. A ZEISS Axio Imager.M2 was used for qualitative analysis. ImageJ was utilized to measure crack lengths and threshold the images to determine 17-4PH dilution. The dilution percentage for the tapered section was calculated by cropping the full height of the interface image, thresholding the red image stack from 36 to 223 to only show the highly saturated red pixels of the gray 17-4PH, then the ratio of white pixels to total pixels was determined using python. Assuming a perfect dilution interface, 50% dilution is expected. Cracking and porosity were quantified in the solid 17-4PH region above the dilution inconsistencies by thresholding the image to differentiate the pores from the 17-4PH. The image was then evaluated using python by determining the ratio of white pixels to total pixels.

Across 10-35 g/min mass flow at 700 mm/min, porosity remained very low and essentially flat for the 17-4PH layers. A representative CT-derived bulk density measured 99.999% (40 μm voxel), and 1 μm optical sections confirmed only small differences across flows, validating that single-section optical porosity was representative of volumetric porosity. Average hardness varied by only ˜15 HV between the lowest and highest flow cases, while EBSD showed more martensite at lower flows and larger grains at higher flows (consistent with higher interlayer temperature and longer thermal exposure). The manufacturing time shortened by >2.5× when mass flow increased from 10 g/min to 35 g/min at otherwise constant parameters, without meaningful loss in density or hardness benefit, tied directly to increased mass input rate at fixed travel.

TABLE 11

| | Mass flow [g/min] | | | | | |
|---|---|---|---|---|---|---|
| | 10 | 15 | 20 | 25 | 30 | 35 |
| Density | 99.93% | 99.89% | 99.88% | 99.83% | 99.81% | 99.82% |

TABLE 12

| Mass flow [g/min] | 10 | 15 | 20 | 25 | 30 | 35 |
|---|---|---|---|---|---|---|
| Cycle Time [min] | 43.5 | 34.5 | 26.5 | 20 | 18.5 | 17 |
| Energy Density | 184 | 134 | 95 | 79 | 71 | 65 |
| [J/mm³] | | | | | | |

Selecting ≥35 g/min mass flow at 700 mm/min yields near-fully dense 17-4PH with hardness shift limited to ˜15 HV, while cutting build time by more than half relative to 10 g/min. The associated benefit is a throughput gain with negligible mechanical penalty, attributed to the martensite-fraction/grain-size changes not materially degrading hardness within the tested window.

For the printing of the copper layers, at 700 mm/min traverse, flow failure initiated 4-6 mm above the substrate due to a combination of high melt mobility and low near-IR absorptivity of the print material. Doubling traverse speed to 1,400 mm/min (same laser power/spot) reduced radiative heat input per unit length and limited melt-pool size, eliminating flow failure while keeping an interlayer dwell (nominally 10 s) to manage heat accumulation. Interlayer temperature traces confirmed markedly higher peaks at 700 mm/min and attainment of a steady-state at 1,400 mm/min, explaining stability improvements. This indicated that traverse speed was crucial to maintain stable copper deposition without nozzle fouling.

Copper porosity depended strongly on energy density and interlayer thermal history. At 20/25/30 g/min, measured densities were ˜99.02%, ˜97.54%, and ˜98.67%, respectively. Microscopy implicated boundary-oxide layers and interlayer discontinuity as the barrier to gas escape at some settings. Interlayer temperature profiles showed the 25 g/min case experienced lower maxima than 30 g/min, consistent with a boundary layer reducing energy coupling. Hardness remained relatively constant (near annealed-copper values), indicating microstructural changes did not translate to large hardness swings. Effective density tuning without over-melting could therefore be achieved by balancing mass flow and energy density to reduce discontinuities between the layers.

TABLE 13

| Mass flow [g/min] | 20 | 25 | 30 |
|---|---|---|---|
| Density | 99.02% | 97.54% | 98.67% |

TABLE 14

| Mass flow [g/min] | 20 | 25 | 30 |
|---|---|---|---|
| Cycle time [min] | 60 | 44 | 36 |
| Energy density [J/mm³] | 150 | 108 | 88 |

Dwell-time control also substantially impacted copper density. At 20 g/min, reducing interlayer dwell from 10 s to 2 s (after the first ˜6 mm had been built) raised the interlayer temperature by ˜9° C. and increased density from ˜99.02% to ˜99.23%, visibly decreasing pore count. The benefit, >0.2 percentage-point density gain without raising laser power, is believed to derive from using higher layer-on-layer temperatures to keep oxide barriers from re-forming while avoiding flow.

Cu/17-4PH mixtures delivered an ideal balance of stability and conductivity. Mixtures from 6.3-93.8 wt % Cu showed >0.5% porosity reduction relative to pure copper under comparable settings, with the most severe hot-cracking confined to 6.3-25 wt % Cu and substantially diminished above ˜50 wt % Cu. EBSD/EDS revealed heterogeneity and phase segregation due to the Cu/Fe miscibility gap. Nonetheless, the 93.8 wt % Cu mixture printed reliably and, importantly, prevented continuous high-conductivity “short-circuit” paths across the interface because steel partitions interrupted copper continuity. The discontinuous copper network in the mixture facilitates high controllable heat flow and improved article printability.

An increase in the relative amount of copper in the mix increased thermal conductivity. Thus, 93.8% Cu delivered ˜13× the conductivity of the mix while being materially more print-stable than pure copper. The near-copper heat-extraction with reduced deposition risk is linked to Cu fraction (conductivity) and the interrupted Cu pathways (crack and flow resistance).

TABLE 15

| Copper [%] | 0 | 25 | 50 | 75 | 87.5 | 93.8 | 100 |
|---|---|---|---|---|---|---|---|
| Thermal | 13.5 | 26.4 | 42.5 | 120.0 | 156.1 | 172.2 | 367.9 |
| Conductivities | | | | | | | |
| [W · m⁻¹ · K⁻¹] | | | | | | | |

For pure copper, an as-printed steel interface exhibited ˜100% separation; machining the copper surface improved dilution but still left ˜>50% separation in a representative case. Adding a targeted preheat raised the interface temperature by ˜25° C. (e.g., from ˜487° C. to ˜512° C.) and reduced separation by ˜48%. The surface state (machined vs as-printed) and preheat-elevated interface temperature result in partial bonding.

TABLE 16

| Condition | Percent Separation |
|---|---|
| Condition 1 | 100% |
| Condition 2 | 95% |
| Condition 3 | 47% |

TABLE 17

| Condition | Condition 1 | Condition 2 | Condition 3 |
|---|---|---|---|
| After copper | 375 | 487 | 389 |
| deposition [° C.] | | | |
| After preheat [° C.] | | | 512 |

When 17-4PH was joined to a 93.8 wt. % Cu mixture, the same surface-conditioning toolkit yielded much stronger bonding. Across eight interface conditions, the best machined conditions achieved ˜0-2% separation along the analyzed interface, while less-prepared surfaces showed higher separation. Measured interface temperatures across conditions (e.g., ˜407-489° C.) correlated positively with fusion quality. Repeatable, near-continuous fusion at the steel/mixture boundary arises from the mixture's higher absorptivity and moderated heat sink behavior relative to pure copper, augmented by machining-induced cleanliness and contact.

TABLE 18

| Condition | Percent Separation |
|---|---|
| Condition 1 | 18% |
| Condition 2 | 87% |
| Condition 3 | 37% |
| Condition 4 | 27% |
| Condition 5 | 0% |
| Condition 6 | 100% |
| Condition 7 | 27% |
| Condition 8 | 26% |

TABLE 19

| Condition | Condition 1 | Condition 2 | Condition 3 | Condition 4 |
|---|---|---|---|---|
| After Copper | 489 | 20 | 20 | 473 |
| Deposition | | | | |
| [° C.] | | | | |
| After Preheat | | 433 | | |
| [° C.] | | | | |

TABLE 20

| Condition | Condition 5 | Condition 6 | Condition 7 | Condition 8 |
|---|---|---|---|---|
| After Copper | 425 | 20 | 20 | 487 |
| Deposition | | | | |
| [° C.] | | | | |
| After Preheat | | | 407 | 527 |
| [° C.] | | | | |

Increased layer-count at the interface can facilitate increased stress-relief. With a tapered, multi-layer steel-on-Cu interface, adding steel layers above the contact increased measured interface density from the mid-90% range to ˜99% while dilution changed only modestly (˜≤15% variation top-of-interface). Reheating cycles from subsequent layers can relax residual stress and close discontinuities, leading to superior crack and pore suppression without over dilution.

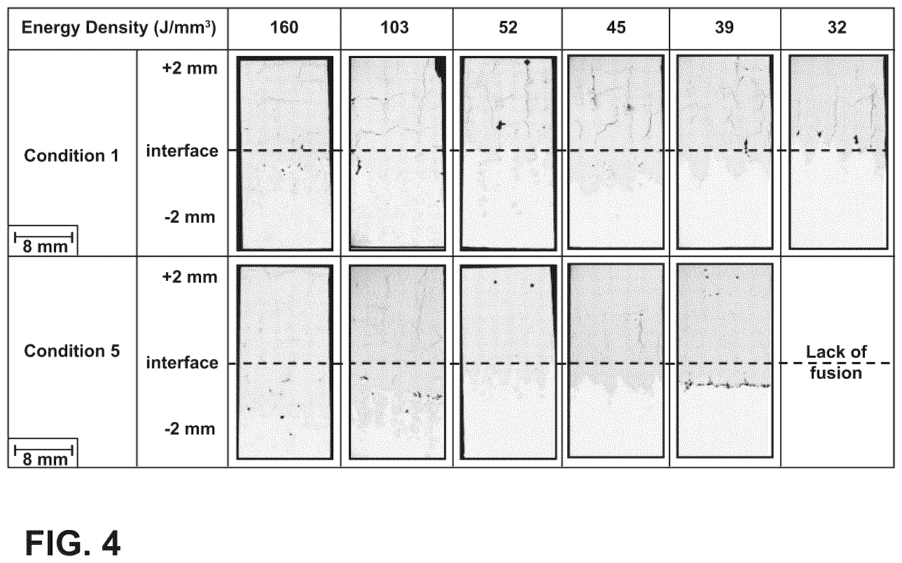

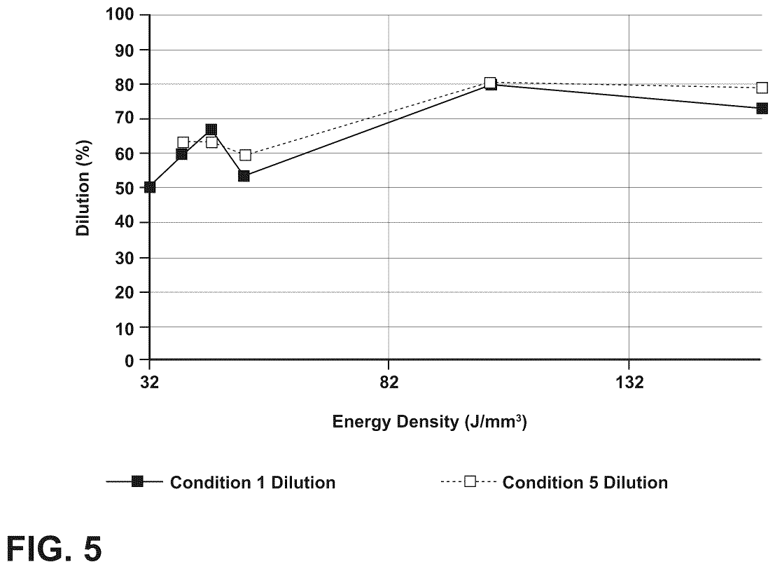

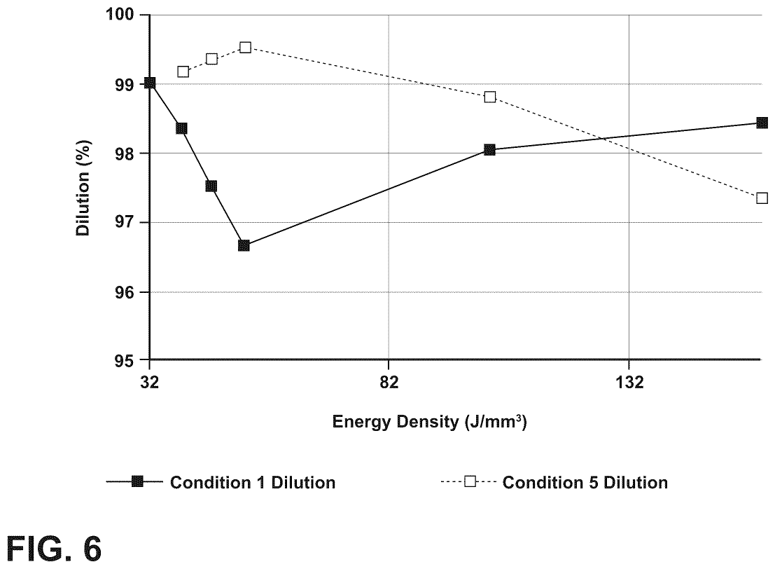

Energy-density is also crucial to interface stability. For both as-printed and machined surfaces, increasing energy density from ˜52 J·mm⁻³ to ˜160 J·mm⁻³ increased metallurgical dilution by nearly 20% and recessed the dilution zone deeper into the substrate. At very low energy densities (˜32-49 J·mm⁻³) lack-of-fusion appeared, whereas at the highest densities the machined case showed more inconsistency (surface-oxide/contamination sensitivity). FIG. 4 depicts the interface between copper and 17-4PH under both Condition 1 and Condition 5 at various energy densities. Dilution and density as a function of energy density under both Condition 1 and Condition 5 are shown in FIGS. 5 and 6, respectively.

For bulk 17-4PH, selecting ˜35 g/min at 700 mm/min (ED on the order of the mid-102 J·mm⁻³ as reported) provides ˜99.9% density and stable hardness with a >2.5× cycle-time reduction versus 10 g/min. For bulk copper, selecting 25-30 g/min with 1,400 mm/min traverse and a reduced dwell (2-10 s, decreased after the first ˜6 mm) delivered up to ˜99.2% density with suppressed flow failures. For dissimilar interfaces, machining and modest preheats improved pure-Cu bonding. For 93.8% Cu mixture interfaces, machining alone achieved full fusion at interface temperatures in the ˜420-490° C. band.

A copper-profile channel insert reached 39.5° C. in ˜18 s during heating and returned to 39.5° C. in ˜23 s during cooling, versus ˜31 s and ˜41 s, respectively, for a steel-profile channel (i.e., ˜1.72× faster heating and ˜1.95× faster cooling for the copper channel under identical cycling). This response advantage is a result of the thermal conductivity values summarized above and was preserved even when the copper region was a copper/steel mixture rather than pure copper.

TABLE 21

| Channel Design | Profile | Arch | Tube | Copper Profile |
|---|---|---|---|---|
| Heat to 39.5° C. | 31 | 34 | 39 | 18 |
| [sec] | | | | |
| Cool to 39.5° C. | 41 | 41 | 47 | 24 |
| [sec] | | | | |

For low-Cu mixtures (≤25 wt % Cu), preheating the substrate did not suppress hot-cracking and in some cases extended crack penetration. Above ˜50 wt % Cu, cracking diminished substantially as segregation patterns changed, while hardness in a 50 wt % Cu sample shifted toward Cu-like values due to immiscibility-driven phase distribution highlighting that “property drift” with composition is non-linear and maps to phase stability. The associated benefit of operating ≥50 wt % Cu is reduced cracking at only a partial conductivity penalty (e.g., ˜120 W·m⁻¹·K⁻¹ at 75% Cu).

The examples show (i) a high-throughput, low-porosity 17-4PH regime; (ii) a stabilized pure-Cu regime using higher traverse and reduced dwell; (iii) Cu-rich mixtures that deliver 13× steel's conductivity (at 93.8% Cu) with superior print stability and strong interfaces after machining; and (iv) interface toolpath strategies that promote metallurgical continuity across dissimilar-material junctions by modulating both local heat input and effective shear strain.

The combined data confirm that the combination of traverse speed, dwell time, and rotational rate produces process windows that balance excellent thermal conductivity without compromising structural integrity. These printing methodologies allow the manufacture of high-duty heat sinks, conformal cooling channels, and electrical tooling components with ideal physical properties.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method of manufacturing a monolithic multi-material article, the method comprising:
additively depositing via laser-based directed energy deposition a first metallic material comprising copper to form a first portion; and
additively depositing via laser-based directed energy deposition a second metallic material comprising a ferrous alloy onto the first portion to form a second portion; and
wherein the first portion and the second portion are metallurgically bonded to form a monolithic article.

2. The method of claim 1, wherein the method further comprises machining at least part of a surface of the first portion to give a machined surface, and wherein the second metallic material is additively deposited on the machined surface.

3. The method of claim 2, wherein the step of machining at least part of the surface of the first portion comprises milling the surface of the first portion to an average surface roughness of less than 5 μm.

4. The method of claim 1, wherein the method comprises maintaining the first portion at a preheat temperature between 200° C. and 600° C. during deposition of the second metallic material.

5. The method of claim 1, wherein the first metallic material is deposited on a substrate comprising a ferrous alloy.

6. The method of claim 1, wherein the laser-based directed energy deposition of the first metallic material or the second metallic material is performed with a laser power between 200 watts and 5000 watts.

7. The method of claim 1, wherein the laser-based directed energy deposition of the first metallic material or the second metallic material is performed at a traverse speed between 200 and 2000 mm/min.

8. The method of claim 1, wherein the laser-based directed energy deposition of the first metallic material or the second metallic material is performed at an energy density of 30 to 200 J/mm³.

9. The method of claim 1, wherein the first metallic material is additively deposited at a mass flow rate of 5 to 50 g/min.

10. The method of claim 1, wherein the second metallic material is additively deposited at a mass flow rate of 5 to 50 g/min.

11. The method of claim 1, wherein the first portion is contacted by inert gas.

12. The method of claim 11, wherein the inert gas is selected from the group consisting of argon, helium, or a mixture thereof.

13. The method of claim 1, wherein the step of additively depositing the first metallic material or the step of additively depositing the second metallic material is performed within an inert atmosphere maintained at an oxygen concentration below 100 parts per million.

14. The method of claim 1, wherein the first metallic material further comprises a ferrous alloy.

15. The method of claim 1, wherein the first metallic material comprises copper in an amount of 70 to 95 wt. %.

16. The method of claim 15, wherein the first metallic material comprises copper in an amount of 90 to 95 wt. %.

17. The method of claim 1, wherein the ferrous alloy is a precipitation-hardenable stainless steel.

18. The method of claim 17, wherein the ferrous alloy is 17-4PH stainless steel.

19. A monolithic article manufactured by the method of claim 1.

20. The monolithic article of claim 19, wherein the monolithic article is a cooling insert for a mold or die.
